(19) United States
(12) Patent Application Publication
(10) Pub. No.: US 2013/0205563 A1
(43) Pub. Date: Aug. 15, 2013

(54) METHODS AND SYSTEMS FOR CONNECTING DISLIKE SHAPED ARTICLES

(71) Applicants: Frederic Zenhausern, Fountain Hills, AZ (US); Nicole Zenhausern, Fountain Hills, AZ (US); Alissia Marguerite Zenhausern, Fountain Hills, AZ (US); Ryan Stephen Zenhausern, Fountain Hills, AZ (US); Amol Surve, Flagstaff, AZ (US)

(72) Inventors: Frederic Zenhausern, Fountain Hills, AZ (US); Nicole Zenhausern, Fountain Hills, AZ (US); Alissia Marguerite Zenhausern, Fountain Hills, AZ (US); Ryan Stephen Zenhausern, Fountain Hills, AZ (US); Amol Surve, Flagstaff, AZ (US)

(21) Appl. No.: 13/750,225

(22) Filed: Jan. 25, 2013

Related U.S. Application Data
(60) Provisional application No. 61/590,562, filed on Jan. 25, 2012.

(51) Int. Cl. B23P 19/04

(52) U.S. Cl. CPC B23P 19/04
USPC 29/428; 29/700

(57) ABSTRACT

A secure and integrated matching of a consumer product box of dissimilar shapes and characteristics to a receiving holder from a moving environmental surroundings, can include a connector configured to selectively connect and position at least one wall from said the box to link with the receiving holder. In a preferred embodiment, the present method and apparatus is suitable for holding a tissue box of any shape in a cup holder of any shape in a vehicle, for example a car.

### FIELD OF THE INVENTION

The invention relates to methods and systems for designing, assembling and producing a connecting device within an article box suitable for dispensing a product, and preferably tissue, when said article box is located in a moving surrounding. The purview of the present invention extends to methods and systems for designing and processing at least a part of a first article box for adapting and/or connecting said first box, to at least a second article holder that are described herein and, in particular, methods and systems for processing an article box, preferably a tissue dispensing carton box to adapt at least one of its component, for connecting with a second holder body, preferably a travel holder such as a cup holder located in a vehicle, for example an automobile.

### BACKGROUND

Latest advances in packaging consumer products for personal use that include features suitable for mobile use, such as in the case of travel, promise benefit to consumer. For example, most current vehicles, in particular automobiles, are equipped with a multitude of article holders for storing, positioning and/or powering a multitude of portable or personal electronic appliances and/or their ancillaries, such as mobile phones, digital media players (e.g. MP3 device, video player, videogame console, or the like), personal computer, including accessories (e.g. USB memory stick, wireless connectivity device), camera and any other digital, communication or entertainment device readily available under current commercial standards. Most of these electronic articles may be affixed to their surrounding environment, for example the dashboard or a cup holder of a car, through readily available adaptation fixtures (i.e. independent or isolated holder) that can connect and secure the articles to their surrounds, in particular to defined location to prevent motion while allowing functional, and within specifications, operation (e.g. energy charging).

There are many consumer products ranging from cosmetics, health care, hygiene, food and so on that comprise articles packaged in a container, for example a carton box, to be delivered, dispensed or used by manual intervention of a consumer such as an individual or a person who may be engaged in a moving action, for example when undergoing transportation or driving a vehicle. A working point for the sake of clarification is now established by referencing article meaning an item to be used or consumed as a product or part thereof (e.g. facial tissue, towel); a box meaning a container comprising, or suitable for receiving, at least one article; a connector meaning a body, part or mean to provide a physical link or bridge between at least two objects; a holder meaning an object which can receive or attach to said box.

It is within the scope of the present invention to provide a suitable interface assembly connecting any of the previously described articles for securing handling in preferably a mobile surroundings, depending on the configuration and nature of the materials used for at least a surface or part of the package shaping said articles, for example a plastic, fabric or carton cover, bag, container or box, an adaptable surface, including a pliable surface, can be provided for handling and connecting of the article with a holder, clamp or other seating object to secure and optimize operational access of the article, for example in a mobile surrounding environment. It is also within the scope of the present invention to provide an article holding of said articles from the family of general description of consumer products, in particular assembling a box in a holder, said box having a multitude of dispensing functions, in particular dispensing of any component (e.g. solid, liquid, gas) contained within the interior or attached onto an exterior surface of the box, and that can be delivered with sufficient precision and functional integrity allowing a user to preserve safe and performing operations within the specifications of said consumer products (e.g. dispensing of facial tissue, hand sanitizer, air fresher) when operation may occur in a surrounding environment that can undergo motion. Although the present invention pertains to those skilled in the art of known prior art, the following description will be directed towards some preferred embodiments related to the combination of adapting, or assembling, or coupling, or engaging of an article box with a holding body. In particular, attention is now directed to the description of an embodiment comprising inserting at least a pliable surface of a first box body that can be deployed in close proximity with at least a few contact points on the surface of said a second holder body, said deployment generating sufficient physical interactions (e.g. friction) between both bodies that can provide assembly for safe, precise and functional operations in preferably a moving surrounding. In particular, a carton box dispenser of facial tissues can be designed and fabricated with at least one of its surface showing a predefined pattern of a connecting component that can be pre-cut in view of its multi-dimensional folding when brought in close proximity with the article holder that can be a cup holder in a car.

Improved capacity in connecting both articles with shapes that can't easily fit their engagement to provide holding can be achieved with the present invention. By designing a pre-cut pattern of said connecting body on one of the surface of the carton box during its standard manufacturing combining processing (e.g. laser cutting, feature printing), precutting, folding and general assembling, any shaped box (e.g. cubic carton box dispensing tissue) can adapt to handle access and positioning within the surrounds of any shaped holder (e.g. circular cup holder) to provide secure positioning while preserving and/or improving dispensing operation, for example. Examples can include the secure and precise disposition of a carton tissue box in a car cup holder, onto a dashboard, a sun visor, air vent, arm or head rest of a seat, door handle or any surrounds of the interior of a vehicle, for example a car, airplane, train, bicycle, motorcycle, vessel, spacecraft or any vehicle that can accommodate an individual involved in a motion or transport.

The prior art of designing upright dispensing box for facial tissue [U.S. Pat. No. 5,415,320] describes embodiments for optimizing the dispensing opening to prevent tearing of the tissue sheets upon removal. The present invention improves on optimizing dispensing of tissue sheets when removal occurs placing the box in a mobile surrounding environment, in particular under travel circumstances or transportation, preferably when the box is connected to a cup holder in an automobile. A multi-ply tissue product which can optimize packaging processing of the tissue sheets assembly while minimizing sloughing has been reported [U.S. Pat. No. 6,797,114B2], as well as cylindrical tissue dispenser that contains retainers to fit engage into a cylindrical cup holder, and other dispenser holder device that play the role of a body carrier inserted in the cylindrical cup holder and supporting the tissue box inserted into said carrier. U.S. Pat. No. 6,318,590 shows a tissue dispensing holder exclusively as a hollow cylindrical container. None of the above inventions or patents taken either singly or in combination, is seen to describe the novelty of the present invention as claimed. None of the above prior art reports adapting the most commercially readily available tissue box products, i.e. “cubic” or “rectangular” cumbersome carton dispenser boxes, to common cylindrical cup holders through at least one integrated connecting body that can be fabricated as a monolithic component of at least one surface of the said carton dispenser box. The present invention doesn't require any specific design of the box as per limiting design parameters and shapes of a cylindrical cup holder to accommodate fit and secure confinement. The present invention recognizes the problems associated with adapting dislike shaped tissue dispenser and holder articles of multiple shapes and functions for adapting said article box in a multitude of surrounds that are preferably part of a traveling body, and preferably in a vehicle, but also onto a movable device (e.g. portable medical instrumentation such as IV Pole, patient bed) to improve user interface for better or safer performance. Furthermore, the present invention provide integration and compatibility of processing for mass manufacturing leveraging standard tool sets that may require minor modification, for example duplication of a programming, pliable, printing, pre-cutting and packaging step to be performed during the manufacturing of the article box. Note the present invention is also considering a diversity of product content within the dispensing box, for example, swabs, towels, food such as candies or any other consumer product an individual may consume during a transport.

### SUMMARY

Accordingly, the embodiments presented herein can provide methods and systems for designing, processing, manufacturing and distributing an article box for dispensing a product or component thereof when the user is involved in a mobile activity, preferably transport, travel, in particular in a vehicle, are described herein and, in particular, methods and systems for adapting connecting a first article box with dislike shape than a second article holder for the purpose of transport or travel.

In one approach, the embodiments can include a method and system for integrating designing, and preferably automated processing of the connector into a standard step of the manufacturing of the article box.

In one approach, the step of designing the connector using a digital CAD drawing algorithm can include the steps of mining databases for comparative design patterns; and comparing the pattern of the connector with a comparative pattern feature from the database.

In one embodiment, the article comprises a cubic shaped carton-based tissue box with a pre-cut design of an orifice onto one of the wall of the cube with a connecting part that can be unfolded in three dimensions preferably into an asymmetric base connector that can then be inserted, for example, into a cylindrical car cup holder. The three-dimensional connecting part can provide friction with the surface of the cup holder and provide some adherence or adhesion between the tissue box and the cup holder allowing the interface of the tissue box with the cup holder that can be suitable for an individual or user to access the tissue sheets through the upper slit allowing the delivery of the tissue sheets for their usage in a mobile environment. Adjustments can then be made for preserving and/or improving the attachment of the tissue box into the cup holder by either complementary folding or applying a slight pressure onto the box, or adding surface treatment such as an adhesive layer or coating, rubber or other polymeric protrusion or the like. The system can optionally include a position and/or pressure sensing device or functional smart materials (e.g. thermo-responsive or piezoelectric materials) for an active coupling between the box and the cup holder that could take the role of a communication means for digital feedback indicating the level of adherence between the articles to ensure secure attachment for improving safety, ease, and efficiency of operations.

Other features will become more apparent to persons having ordinary skill in the art to which the package pertains and from the following description and claims.

### BRIEF DESCRIPTION OF THE DRAWINGS

The above and other aspects, features and advantages of the present embodiments will be more apparent from the following more particular description thereof, presented in conjunction with the following figures, wherein:

FIG. 1 is a schematic overview of (i) the prior art teaching inserting symmetrical matching shapes of a cylindrical tissue box into a cylindrical cup holder and (ii) one embodiment of the present system and method to connect an article box of any shape to a holder of any shape using a pliable connector patterned onto at least one wall of said article box that can be unfolded to provide a mean to connect with a receiving holder.

FIG. 2 (A,B,C,D) illustrate a multitude of design, shapes, materials that can be produced on the article box through integration during the manufacturing processing or as an independent part to be attached to said the article box and accordingly to several of the described embodiments.

FIG. 3 is a system flow diagram in accordance with the method for designing, processing and deploying one embodiment of the invention shown in FIG. 1; and

FIG. 4 emphasizes two preferred types of connection between two articles and, for example a tissue box and a cup holder allowing sufficient resistance between said articles to allow active delivery of the content of said tissue box, preferably during a motion.

FIG. 5 illustrates a sequence of images illustrating the positioning and deployment of the preferred embodiment, i.e. a tissue box placed in proximity to a cup holder of dissimilar shapes providing a stable connection.

Corresponding reference characters indicate corresponding components throughout the several views of the drawings.

### DETAILED DESCRIPTION

The following description is not to be taken in a limiting sense, but is made merely for the purpose of describing the general principles of exemplary embodiments. The scope of the invention should be determined with reference to the claims. The present embodiments allow improved operability of a consumer product, in particular when packaged into a dispensing box such as tissue box. In particular, the present embodiments provide necessary components and processes to preferably integrate designing, fabricating of a connector means from the box which can then be brought in close proximity of a holder, such as a cup holder located in a vehicle, to accommodate a surround of the box in relative positioning between the box, holder and user when moving. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Despite advances in the art, improvements in consumer product delivery and consumer care are possible and desired. Such improvements could include faster, safer and more efficient locating, dispensing, and article usage. As an added benefit, these types of improvements could potentially also be applied to other areas of applications such as food dispensing, accessing information or any related user interface known in the prior art, including an individual or person under hospital stay in a patient bed, or moving with a IV pole. Other content of a box-type of packaged product for the purpose of continuous or sequential delivery or access of at least one component of said content is also within the scope of the present invention. For example, hardware parts such as screws, nails but also electronic components such as transistors, resistors, but also medications in the form of pills, tablets or any other component packaged into individual parts packaged in a box could be included providing similar benefits to the user as it was described previously.

The following definitions are provided to assist in understanding some embodiments of the present methods and systems. Unless specifically defined otherwise, all technical and scientific terms used herein have the same meaning as commonly understood by one of ordinary skill in the art of the present embodiments. Generally, the nomenclature used herein and the manufacturing procedures in automated packaging assembly, consumer product manufacturing and distribution described below are well known and commonly employed in the art. Unless specifically described otherwise, conventional methods are used for the fabrication procedures, such as those provided in the art. Where a term is provided in the singular, the plural of that term should also be contemplated. The nomenclature used herein and general manufacturing procedures described herein are known and commonly employed in the art. As employed throughout the disclosure, the following terms, unless otherwise indicated, shall be understood to have the following meanings:

“Box” can be any container article and, for example, a tissue box, a towel box, or a package of a product suitable for consumption, for example, sheets of any materials (e.g. paper, textile, plastics), possibly in a controlled moisture environment, or under solar or any other external radiation protection.

A “vehicle” is a means of transportation, for example a vehicle such as a train, a car, an automobile, a motorcycle, a vessel, an airplane or any other mode of transport known by those skilled in the art.

A “user” is a person who is preferably interacting with a consumer product for its usage such as facial cleaning, controlling release of biological fluids (e.g. tissue for nose discharge, ear wax cleaning, etc.) or any other hygienic action while the person is engaged in an activity that involves motion, transportation, travel or the like.

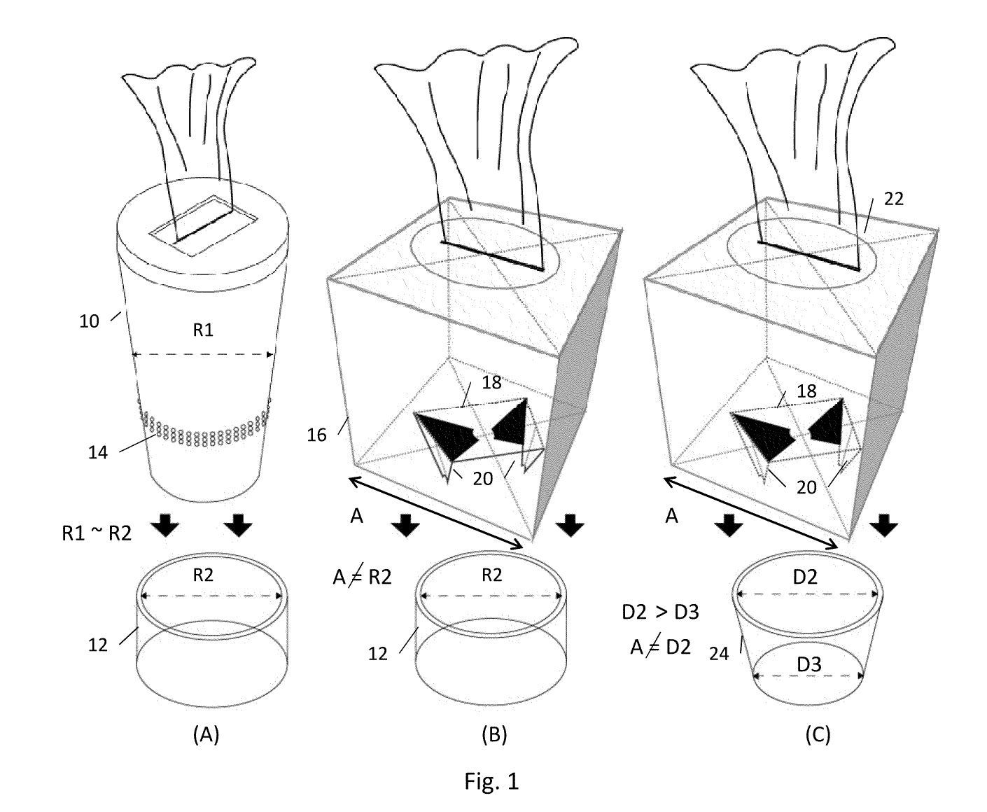

Turning now to the figures, FIG. 1a illustrates a schematic overview of some prior art described in U.S. Pat. No. 6,318,590B1 issued to McMurray-Stivers, and FIG. 1 b-c show the diagrams of the present invention illustrating its novelty over the prior art. McMurray-Stivers introduces a cylindrical dispenser -10- that requires insertion into a cylindrical cup holder -12- of same symmetry and of closely similar dimensions, through retention means -14- all around the cylindrical circumference of the dispenser, to exert pressure and friction with the sidewalls of the symmetrical cup holder to hold position. This embodiment requires adjusting the dimensions and symmetry of the dispenser and cup holder in tight control within tolerances of the size of the retention means, typically within a few millimeters. So, the diameter 2×R1 of the dispenser has almost similar dimensions than the diameter of the cup holder 2×R2, and in the relation of R1˜R2. The present invention provides a novel method and apparatus that allow connecting any shaped article (e.g. dispenser) -16- to any shaped receiving article (e.g. cup holder) -12- through a connector -18- that is integrated within a wall of said first article which can be released into a three-dimensional arrangement -20- suitable for holding all articles. It is also obvious to those skilled in the art that the present invention also has several benefits during the manufacturing as the connector can be designed and fabricated during the conventional processing steps of conventional packaging manufacturing conditions. The arrangement -20- can comprise at least one component that can fold in a spatial configuration such as three-dimensional means that can interact, for example, through a mechanical force (e.g. friction, adhesion) or an electromagnetic force or field gradient in the case of an active actuation (e.g. electromagnet) that can be generated when a power source could be connected between the said articles. For example, the arrangement can allow versatile adjustment either through a constant or a variable physical interaction between said a dispenser -A- and a cup holder -12- suitable for connecting articles that can be dislike in shape, geometry, materials composition or any physico-chemical properties that may be of relevance to the intrinsic nature of the individual articles. The present invention provides capacity of engaging connecting articles in different relationships, such as A≠R2 or for example in the case of a second article such as a cup holder with dimensions A>D2>D3, as it is illustrated in FIG. 1C. Note that the article -16- preferably will comprise an opening means -22- on one of its walls for dispensing the content of said article (e.g. a tissue sheet).

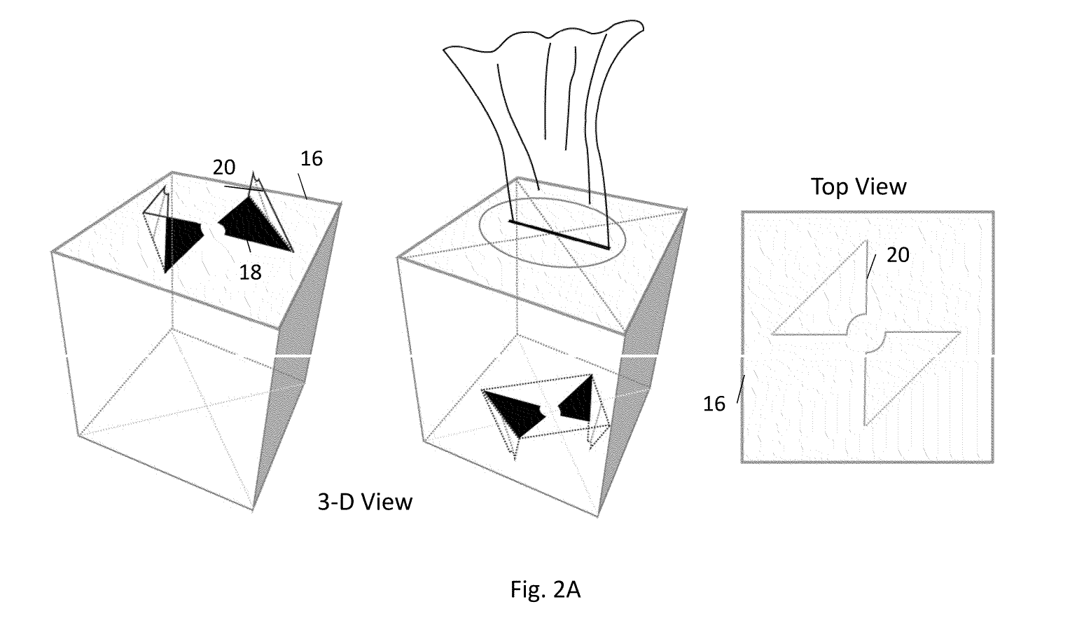

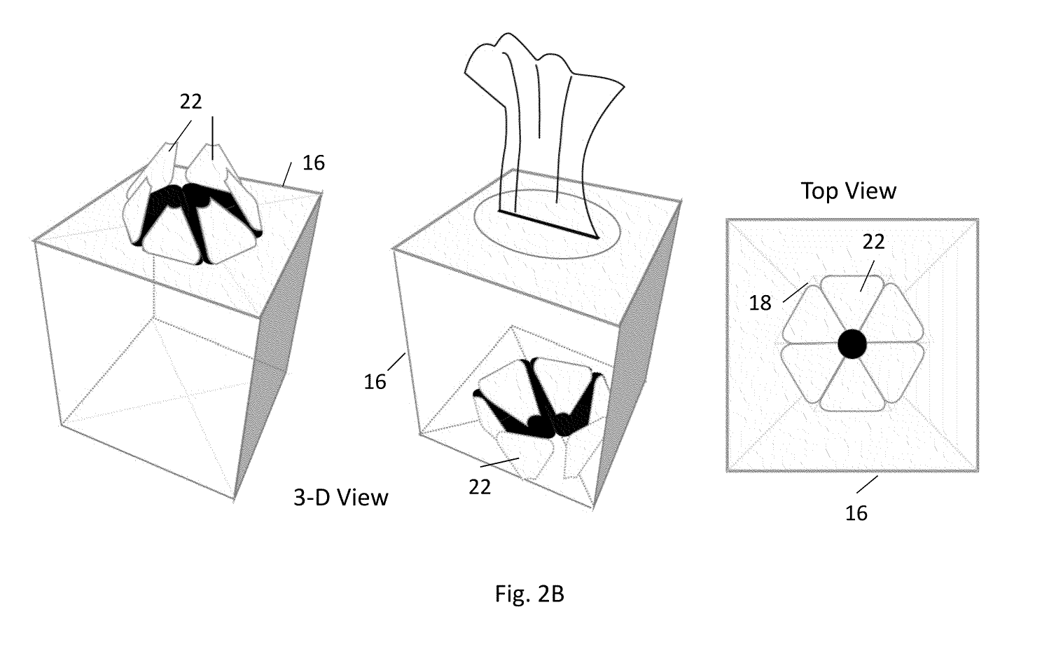

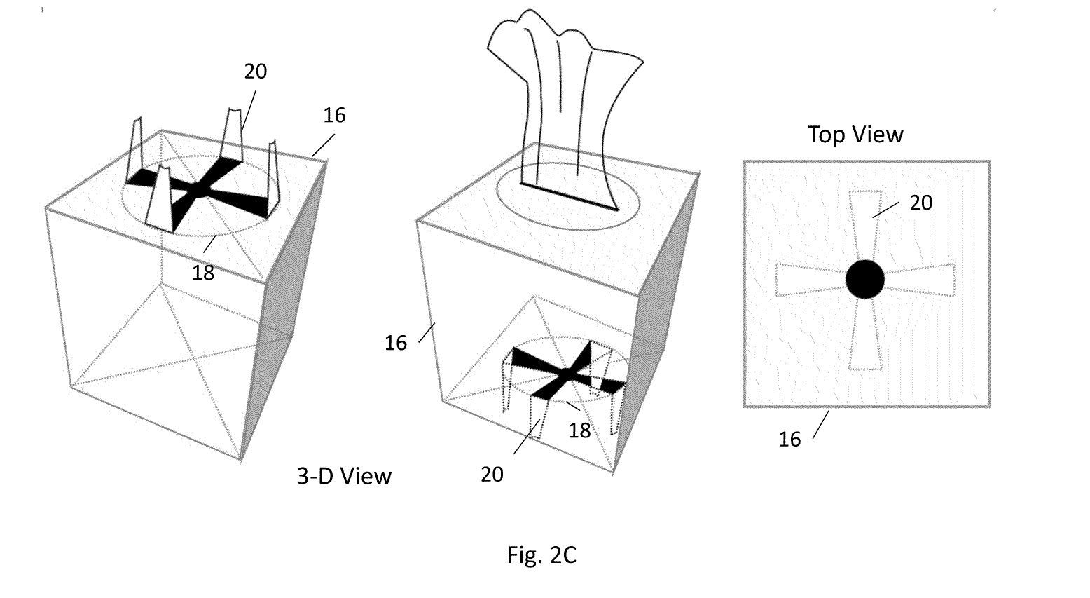

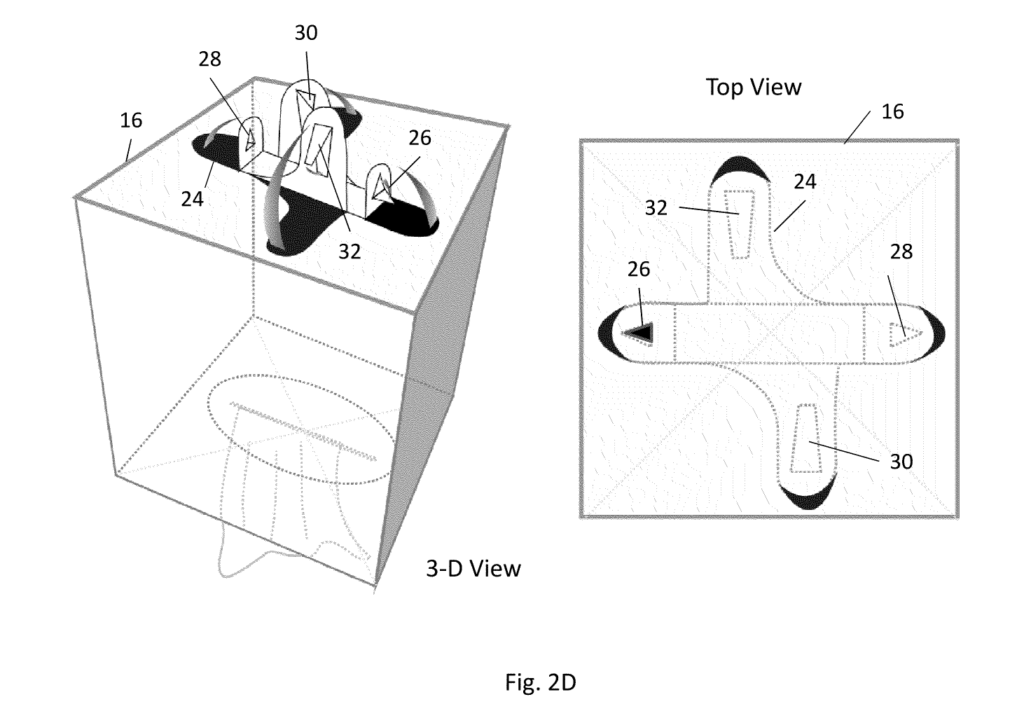

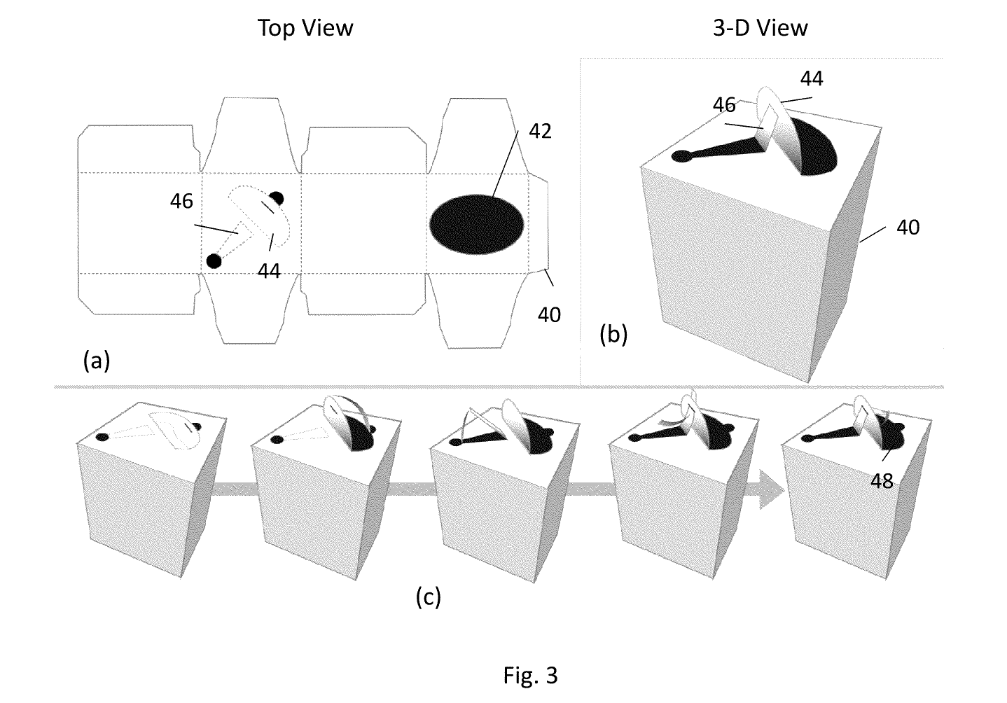

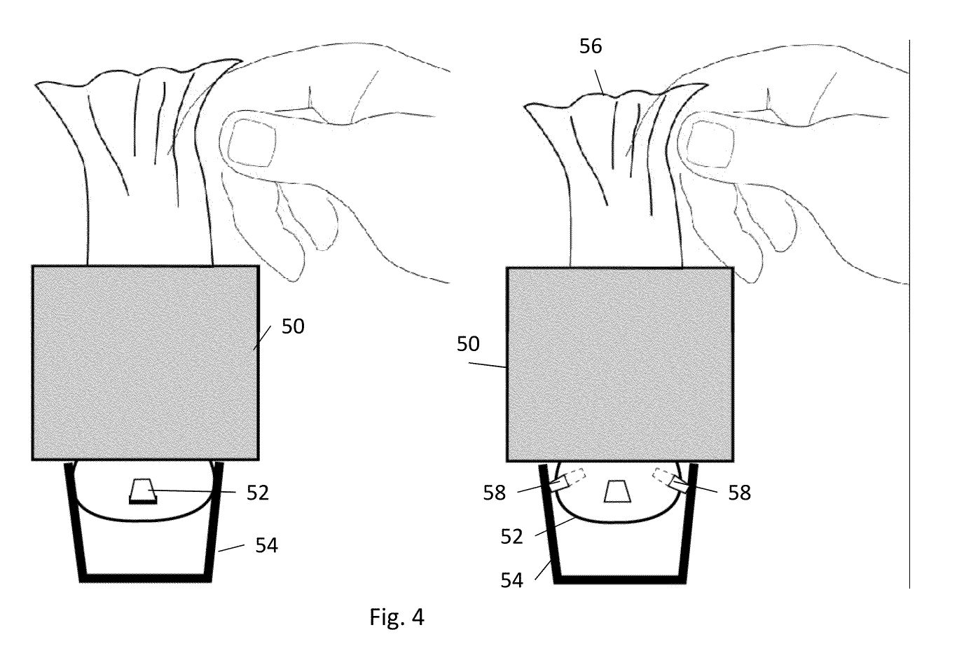

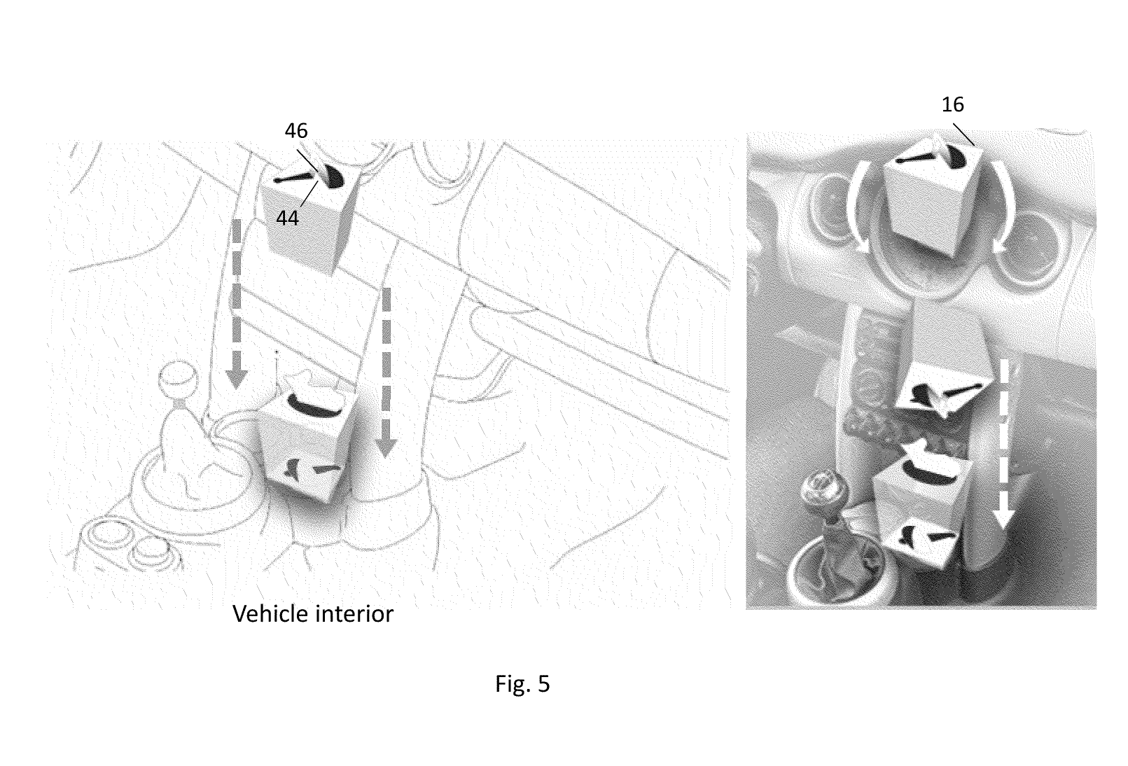

FIG. 2 (A,B,C,D) illustrate examples of a multitude of geometrical and spatial designs and configurations with 3-D and top view illustrations of a preferred embodiment of a tissue box -16- and its connector arrangement -18- and components -20 that can be arranged in a symmetrical pattern (e.g. FIG. 2 A,B,C), such as a clover motif (e.g. FIG. 2B) or in asymmetrical pattern (e.g. FIG. 2D) which may also contain sub-components 24-30 suitable to assist individually or in combination during the mechanism of connecting said box to said holder. For example, a sub-component can be a curve line defining a random pattern connector that can be pliable, or including pillar -26-, groove -28, rod -30- or any other combination of shaped sub-component such as anchor-like object -32-. Now attention is directed towards FIG. 3 showing a preferred embodiment of a tissue box -40- with a dispensing opening -42- onto one of its walls (e.g. top wall) and a pliable pattern comprising a connector that can be comprised of at least a part -44- and a supporting part -46-. FIG. 3a, shows a top view of an unfolded two dimensional diagram of one of the preferred embodiment of the present invention, while FIG. 3b illustrates a three-dimensional view of the invention. FIG. 3c illustrates a sequence of steps for the spatial deployment of the connector of one preferred embodiment of the present invention. For example, the wall -48- of the tissue box will represent the bottom surface which can then be inserted in a holder that can allow securing a typical cubic and commercially available tissue box into the cup holder of a car so that a driver or passenger could access the content of the box and dispense tissue safely and accurately while the vehicle may be in motion. FIG. 4 illustrates another preferred embodiment placing a first cubic article -50- with its unfolded connector -52- inserted into a second article of dissimilar shape, for example a cylindrical cup holder, wherein a configuration can comprise a connector surface is directly engaged in a frictional force with the walls of the cup holder to apply pressure and provide safe attachment of said box and allowing active delivery of the content -56- without significantly unlocking the position of both articles. A configuration using discrete part thereof -58- of the connector -52- for positioning and locking the first article in close proximity of said second article by exerting contact and possibly pressure of parts -58- with the wall of the holder -54- is also illustrated in the FIG. 4.

While the figures and descriptions herein have been described in conjunction with specific embodiments, many alternatives, modifications, and variations will be apparent to those skilled in the art in light of the foregoing description. Changes in form, as well as substitution of equivalents, are contemplated as circumstances may suggest or render expedient.

What is claimed is:

1. A method for connecting a first article to a second article, and said articles exhibiting dissimilar shapes, to provide a surround with characteristic features that can produce a functional quality of said first article when it is operated under the conditions of moving, the method comprising:
1) designing a pattern of an object onto a wall of a first article, the object designing preferably releasing into a three dimensional pliable connector from the article that can join to a second article or part thereof;
2) processing the pattern of the object when manufacturing the first article, provided fabricating at least one part of the object using some characters of molding, cutting, folding, pressing, printing, assembling, packing or other conventional steps of packaging production;
3) supplying at least one component of content in the first article, said content to be dispensed by an action of a user engaged in moving;
4) placing the first article in close proximity to the second article adapting at least one change in the at least one spatial arrangement of the connector of said first article to provide at least a physical combination of surround for holding with the second article, both articles having preferably dissimilar shapes;
5) operating the first article in the surround when a user is involved in an environmental mode suitable for moving, and preferably said mode of travel, transport, motion or placing the user in any mobile vehicle, wherein all articles are located; and
6) distributing the content of the first article to the user to provide the characteristic functions of product of said first article in at least a safe, efficient, secure, or fast ways to assist the user in better experiencing the product outcome.

2. The method of claim 1, wherein the step of designing the connector comprises using a computer assisted drawing algorithm or software.

3. The method of claim 1, wherein the fist article is from the category of consumer products, for example tissue or towel sheets in a package, cosmetic powder or liquid or paste contained in a compartment with at least a wall with a geometrical shape.

4. The method according to claim 1 wherein the second article is an object comprising at least a cavity that can receive another object or part thereof, preferably with the function of holding

5. The method according to claim 1 wherein the second article comprises a cup holder from a car or a vehicle, such as a truck, a train, a spacecraft or an airplane

6. The method according to claim 1 wherein the conditions of moving is a transportation, travel or displacement.

7. The method according to claim 1 wherein processing the pattern is performed in the sequence of manufacturing, for example by laser cutting, pinching into a materials to replicate the pattern on a wall of said first article, preferably a carton box to provide contours that could then be folded to form a connector

8. The method according to claim 7 wherein the connector is a piece of carton in the shape of a leg.

9. The method according to claim 1, wherein processing is performed in a computerized manufacturing process.

10. An apparatus for connecting a first article to a second article, and said articles exhibiting dissimilar shapes, that can provide a surround with characteristic features that can produce a functional quality of said first article when it is operated under the conditions of moving, the apparatus comprising:
1) an object patterned onto a wall of a first article, the object preferably releasing into a three dimensional pliable connector from the article that can join to a second article or part thereof;
2) one component of content in the first article, said content to be dispensed by an action of a user engaged in moving;
4) the connector of said first article that can engage in a physical combination of surround for holding with the second article, both articles having preferably dissimilar shapes;
And
5) a means for a user to access the content of said first article when the user is in motion and preferably traveling in a vehicle.
